(19) United States
(12) Patent Application Publication
(10) Pub. No.: US 2014/0121903 A1
(43) Pub. Date: May 1, 2014

(54) SYSTEM AND METHOD FOR IMPROVING DRIVING SAFETY OF VEHICLE

(71) Applicant: HYUNDAI MOTOR COMPANY, Seoul (KR)

(72) Inventor: Seung Hwan Lee, Hwaseong (KR)

(73) Assignee: HYUNDAI MOTOR COMPANY, Seoul (KR)

(21) Appl. No.: 13/693,805

(22) Filed: Dec. 4, 2012

(30) Foreign Application Priority Data
Nov. 1, 2012 (KR) 10-2012-0122768

(51) Int. Cl. G06F 17/00

(52) U.S. Cl. CPC G06F 17/00
USPC 701/41; 701/36

(57) ABSTRACT

Disclosed herein is a system for improving safety stability upon operation of in-vehicle apparatuses during driving including a left touch sensor disposed on a left region of a steering wheel gripped by a left hand of a driver configured to sense a contact of the left hand with the steering wheel to output a signal; a right touch sensor disposed on a right region of a steering wheel gripped by a right hand of the driver and configured to sense a contact of the right hand with the steering wheel to output a signal; an operation unit disposed in an operation unit of a center fascia configured to sense a hand touch and output a signal; a controller, configured to receive the signals from the left touch sensor, the right touch sensor, and the operation unit touch sensor to determine a contact of the driver hands with the operation unit of the center fascia and then output a control signal for displaying operation unit information comprising a type and a purpose of the operation unit touched by the driver hand and a current operation location and state; and an information display disposed at a front of a driver seat and configured to display the information of the operation unit touched by the driver hand in response to the control signal of the controller.

### CROSS-REFERENCE TO RELATED APPLICATION

This application claims under 35 U.S.C. §119(a) the benefit of Korean Patent Application No. 10-2012-0122768 filed Nov. 1, 2012, the entire contents of which are incorporated herein by reference.

### BACKGROUND

(a) Technical Field

The present invention relates to a system and method for improving the driving safety of a vehicle. More particularly, the present invention relates to a system and method for improving the driving safety of a vehicle, which can further increase the driving safety when a driver operates in-vehicle apparatuses while driving.

(b) Background Art

The recent developments in auto industries has increased customers demands for a more convenient, reliable and intelligent vehicle. In response, vehicles have been equipped with various convenience apparatuses, safety apparatuses, and driving assisting apparatuses. For example, various apparatuses such as air conditioning apparatuses, audio/video systems, navigation systems providing map and traffic information, and apparatuses for providing video information, driver supporting information, vehicle information, and driving information are being developed and equipped in the vehicles.

As new technologies are being increasingly introduced in vehicles, the number and type of in-vehicle apparatuses are also increasing, and thus the number of operation units, such as buttons and switches, that a driver may or must operate while driving are increasing.

A driver operates the buttons or switches to operate a variety of functions, usually a series of actions, such as operation of the buttons or switches, identification of operated state and re-operation of the buttons and switches to adjust the operated state to a desired state.

Particularly, during the above process, a driver must go through a process of searching and selecting the location and type of buttons and switches and checking the current state of the corresponding function. A driver also needs to check the current mode among many modes, and check, finish or repeat the operated and changed state. Thus, a driver averts attention away from the traveling direction of vehicle to the operation units (e.g., buttons, switches, knobs, dials, etc.). It may be difficult for a driver to promptly respond to situations such as a sudden appearance of obstacles or a sudden stop of the vehicle in front, thereby increasing the risk of an accident.

Moreover, when a driver operates the buttons or switches while driving, a risk of a collision, deviating from the lane or driving over the centerline may occur while a driver is not looking forward.

Particularly, the operation part for operating apparatuses such as air conditioner, audio/video system, and navigation system may be disposed in a center fascia of a vehicle, thus, when a driver operates the operation part in the center, the risk of an accident increases because of dispersed attention caused by posture of a driver and handling of the steering wheel becomes unstable (due to the change of posture, there is a possibility of unconscious handling or misoperation of the steering wheel). It is well-known that when a driver acquires information from the information display apparatuses located at the front of the driver's seat, such as a cluster or a Head-Up Display (HUD), the possibility of accident occurrence and the degree of risk are greater due to the dispersion of attention and sight.

The above information disclosed in this section is only for enhancement of understanding of the background of the invention and therefore it may contain information that does not form the prior art that is already known in this country to a person of ordinary skill in the art.

### SUMMARY

The present invention provides a system and method for improving driving safety of a vehicle, which can further improve the driving safety when a driver operates an operation part in a center fascia of the vehicle.

In one embodiment, the present invention provides a system for improving safety stability upon operation of in-vehicle apparatuses during driving, the system including: a left touch sensor disposed at a left region of a steering wheel gripped by a left hand of a driver and configured to sense a contact of the left hand with the steering wheel to output a signal; a right touch sensor disposed at a right region of a steering wheel gripped by a right hand of the driver and configured to sense a contact of the right hand with the steering wheel to output a signal; an operation unit touch sensor disposed in an operation unit of a center fascia to sense a hand touch and output a signal; a controller receiving the signals from the left touch sensor, the right touch sensor, and the operation unit touch sensor to determine a contact of the hands of the driver with the operation unit of the center fascia and then outputting a control signal for displaying operation unit information including a type and a purpose of the operation unit touched by the hand of the driver and a current operation location and state; and an information display disposed at a front of a driver seat and configured to display the information of the operation unit touched by the hand of the driver according to the control signal of the controller.

In another embodiment, the present invention provides a method for improving safety stability upon operation of in-vehicle apparatuses during driving, the method including: receiving, by a controller, signals from a left touch sensor and a right touch sensor configured to sense a contact of a left hand and of a right hand with the steering wheel and a signal from an operation unit touch sensor disposed at each operation unit of a center fascia configured to sense a hand touch and determining the hand touch of a driver with the operation unit of the center fascia; outputting a control signal for displaying operation unit information including a type and a purpose of the operation unit touched by the hand of the driver and a current operation location and state; and displaying, by an information display disposed at a front of a driver seat, the information of the operation unit touched by the hand of the driver according to the control signal of the controller.

### BRIEF DESCRIPTION OF THE DRAWINGS

The above and other features, objects and advantages of the present invention will be described in detail with reference to exemplary embodiments thereof illustrated the accompanying drawings which are given hereinbelow by way of illustration only, and thus are not limitative of the present invention, and wherein:

FIG. 1 is an exemplary view illustrating a vehicle equipped with a driving safety improving system according to an exemplary embodiment of the present invention;

FIG. 2 is an exemplary view illustrating a configuration of a driving safety improving system according to an exemplary embodiment of the present invention; and

FIG. 3 is an exemplary flowchart illustrating a method of a driving safety improving system according to an exemplary embodiment of the present invention.

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules/units and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

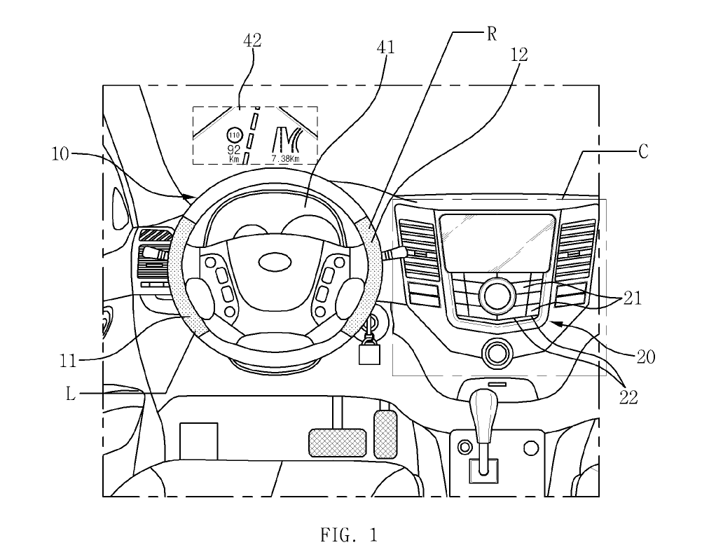

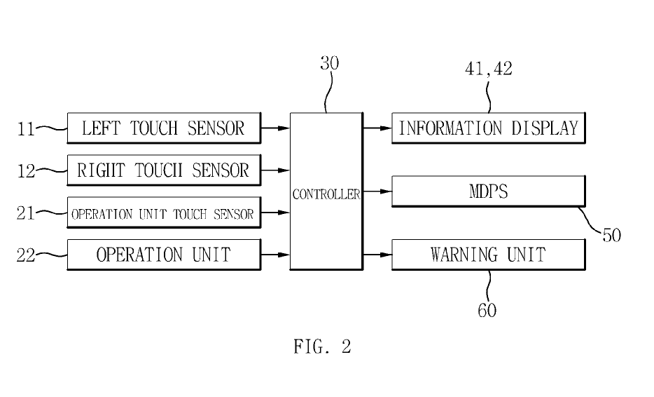

FIG. 1 is an exemplary view illustrating a vehicle equipped with a driving safety improving system according to an embodiment of the present invention, and FIG. 2 is an exemplary view illustrating a configuration of a driving safety improving system according to an embodiment of the present invention.

As shown in the FIG. 1, the center fascia 20 may include an operation part for operating various apparatuses inside a vehicle. The operation part may include an operation unit 22 including a plurality of buttons, switches, knobs, and dials to operate various apparatuses inside a vehicle. For example, the operation part may include buttons, switches, and a touch panel (embedded in a display) for operating a navigation device. In addition, the operation part may further include various types of buttons or switches for operating various apparatuses such as an air conditioner, an audio, a video, a seat heating wire apparatus, and a glass heating wire apparatus in a vehicle.

In this embodiment, the operation unit 22 in the center fascia 20 may be a portion or all of well-known operation units (e.g., buttons, switches, knobs, dials, and touch panels) installed in a vehicle, and will not be limited a specific form in its type, operation method, and operation purpose.

In addition, when liquid crystal display (LCD) type displays, not embedded in a vehicle, like a touchscreen include indicating windows showing the air-conditioning mode, set temperature, and playing music, and such information, the display must be monitored and operated by a driver during the vehicle operation. Furthermore, various operation units and apparatuses used by a driver in a vehicle should be construed as included in the operation part.

A driving safety improving system according to an embodiment of the present invention may include right and left side touch sensors 11, 12 disposed on a steering wheel 10 gripped by a driver for driving. The right and left side touch sensors 11, 12 may be disposed on divided regions of the steering wheel. In other words, the steering wheel 10 may be partitioned into a left region L gripped by the left hand of a driver and a right region R gripped by the right hand of the driver, and the touch sensors 11, 12 may be disposed on each region, respectively, to detect the contact of the driver (e.g., driver hands or finger). The touch sensors 11, 12 may output an electrical signal in response to a touch by a driver. The signals (e.g., contact/non-contact signals) outputted from the touch sensors 11, 12 may be inputted into a controller 30.

Hereinafter, the touch sensor 11 disposed on the left region L of the steering wheel 10 to detect whether or not the left hand of a driver contacts the steering wheel will be referred to as a left touch sensor, and the touch sensor 12 disposed at the right region R of the steering wheel 10 to detect whether or not the right hand of the driver contacts the steering wheel will be referred to as a right touch sensor.

In addition, the driving safety improving system according to this embodiment may include separate touch sensors 21 that are individually disposed on each operation unit 22 of a region (e.g., region C in FIG. 1, hereinafter, referred to as a center fascia operating region) of the operation part located in the center fascia 20 to detect a driver touch. The touch sensors 21 of each operation unit 22 may detect the touch of the driver hands or a passenger to output electrical signals according thereto. The signals outputted from the touch sensors (hereinafter, referred to as an operation unit touch sensor) 21 of the operation unit 22 may be inputted into the controller 30.

The driving safety improving system may include the controller 30 configured to receive the signals from the left touch sensor 11 and the right touch sensor 12 of the steering wheel 10, the signals from the operation unit touch sensor 21, and operation signals according to the operation of each operation unit 22. Furthermore, the controller 30 may receive the signals from the left touch sensor 11, the right touch sensor 12, and the operation unit touch sensor 21 to determine whether or not the driver contacts a specific operation unit 22 of the center fascia 20 to operate the apparatuses inside a vehicle and thus, may control the operation of the cluster 41 and/or the head-up display 42.

More specifically, when the controller 30 determines, using the signals from the left touch sensor 11, the right touch sensor 12 and the operation unit touch sensor 21, whether or not the driver contacts a specific operation unit 22, the controller 30 may control the operation of the cluster 41 or the head-up display 42 to display information of the operation units such as type and purpose of the operation units 22 operated by a driver and current operation location and operation state (e.g., current operation location and operation state before or after the operation of a driver)

Since the controller 30 may to receive the operation signals according to the operation of the operation unit 22, a driver may operate an actual operation unit, and the controller 30 may control the operation of the cluster 41 or the head-up display 42\ to display the operation state (e.g., functional change state by operation of apparatuses). Furthermore, the information may be displayed at a front of a driver seat. This display on the driver seat may be distinguished from other displays such as displays (e.g., unit for displaying the state of existing operation units) inside the center fascia 20. The information displayed may allow a driver to check displayed information without averting attention from the direction of travel, and may be the cluster 41 and/or the head-up display 42, but is not limited thereto.

When a driver drives a vehicle with only one hand while for a certain time (e.g., in other words, when one-hand driving state lasts for a predetermined time), the controller 30 may be set to warn a driver. Moreover, the driving safety improving system may include a warning unit 60 for warning a driver of a one-hand driving state according to a control signal of the controller 30. The warning unit 60 may be a warning sound outputting unit for outputting a warning sound, or may be an information display, i.e., a cluster or a head-up display for visually displaying a warning situation at the front of the driver seat.

Additionally, when a driver drives a vehicle with one hand, the controller 30 may control the handling sensitivity of a Motor Driven Power Steering (MDPS) 50 (e g making the steering wheel less sensitive). In particular, when a driver drive a vehicle with one hand, the controller may output a control signal for controlling steering of a driver, and the control signal may allow the operation control of an MDPS motor for controlling the steering of the vehicle. Thus, when a driver drives a vehicle with one hand, the steering of a driver may be controlled by a MDPS motor to increase the steering stability (e.g., handling stability). In the steering controlling process, the controller 30 may perform the steering control in cooperation with a steering apparatus controller for controlling the operation of the MDPS motor.

When the controller 30 outputs a control signal for controlling the steering, the steering apparatus controller may receive the control signal to control the operation of the MDPS motor for the steering control. In particular, when the steering apparatus controller outputs a control signal for limiting a current value of driving force, the driving force of the MDPS motor may be reduced by the limitation of the current value to control the steering of a driver, which is called a current value limitation method.

The reduction of the driving force of the MDPS motor (e.g., reduction of steering assist) may make the steering of a driver difficult (e.g., steering control). When the driving force of the MDPS motor is reduced, the steering force assisted by the MDPS motor may be reduced, causing the steering to feel heavy and the steering to be controlled.

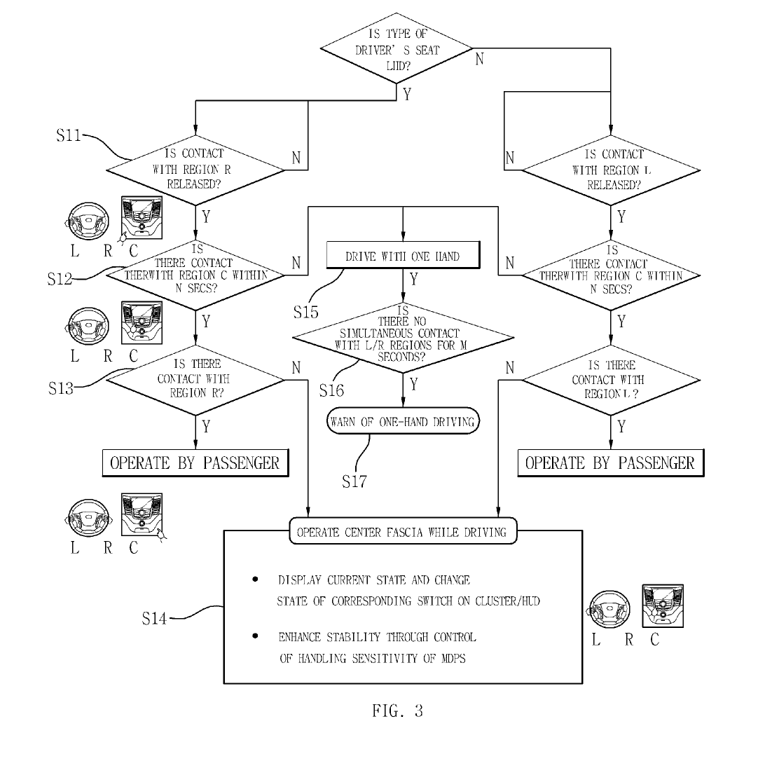

Hereinafter, a driving safety improving method, i.e., a process of operating the driving safety improving system according to an embodiment of the present invention will be described with reference to FIG. 3.

When the driving seat is located at the left side in a vehicle (i.e., Left-Hand Drive (LHD)), the controller 30 may detect, through a left touch sensor 11 and a right touch sensor 12, when a driver grips a left region and a right region of the steering wheel 10. When a driver release off the right hand from the steering wheel 10, the controller 30 may receive a contact (e.g. a touch) release signal from the right touch sensor 12.

Thus, when the contact with the right region R of the steering wheel 10 is released (S11), the controller 30 may receive a signal indicating there is a touch (e.g., a hand touch) from the touch sensor 21 of a specific operation unit 22 located in the center fascia operation unit region C within a predetermined time (N seconds) (S12). Thereafter, when the controller verifies through the right touch sensor 12 that a touch on the right region of the steering wheel 10 is not made (S13), it may be determined that the operation unit 22 of the center fascia 20 is touched by the driver during driving (S14).

Furthermore, the controller 30 may display information about the specific operation unit 22 touched by a driver, i.e., the type and purpose of the operation unit 22 (e.g., information on a switch such as, air-conditioning mode or set temperature is touched by a driver) and currently-controlled operation location and state (e.g., current functional state of a corresponding unit, such as, newly set air-conditioning mode or set temperature information) on the cluster 41 or the head-up display 42 which may be an information display at the front of the driver seat.

As a result, since a driver may receive the information about the touched operation unit 22 by contacting the various operation unit 22 in the center fascia 20, a driver may search for and verify the location of the operation unit to be operated without looking at the center fascia, and may find a desired operation unit without averting attention from the direction of travel to the center fascia.

Further, when a driver operates the operation unit 22, the controller 30 may receive an operation signal of the operation unit to display the operated location or state (e.g., functional state of apparatuses) on the cluster 41 and/or the head-up display 42. Thus, a driver may search for the location and information of the operation unit 22 and may easily perform operation of a described apparatus without looking at the center fascia 20 while verifying the information displayed on the cluster 41 or the head-up display 42.

Accordingly, when a driver operates the operation part (e.g., the operation units) in the center fascia, a driver may operate in-vehicle apparatuses by viewing the information of the cluster 41 or the head-up display 42 which is disposed relatively lower than the center fascia 20. As a result, since a driver may operate the operation units without looking at the center fascia 20, thereby improving driving safety.

In the above process, when the operation signal of the operation unit is input when the right hand contact is not released from the right region of the steering wheel, and a hand contact with a specific operation unit within a predetermined time is verified, thereafter when there is a contact with the right region of the steering wheel, it may be determined that the current operation of the operation unit in the center fascia is performed by a passenger (S13).

When the controller 30 verifies that a driver is operating the operation unit 22 in the center fascia 20, the controller 30 may reduce the driving force (e.g., steering assist), thereby reducing driving control of the drive (e.g., driver steering control). Thus, it may be possible to prevent unconscious misoperation of a driver that may occur when a driver grips the steering wheel only with one hand or operates an operation unit in the center fascia (e.g., steering stability is improved) and prevent occurrence of an accident due to the misoperation of the steering wheel.

In addition, the controller 30 may actuate a warning unit 60 for warning one-hand driving by verifying through the left and right touch sensors 11, 12 that a simultaneous contact of both hands with the steering wheel 10 is not made for a predetermined time (M seconds) (e.g., one-hand driving of a driver is maintained for a predetermined time) after the contact of the right hand of a driver with the steering wheel 10 is released. Thus, it may possible for a driver to search for and operate the operation unit 22 in the center fascia 20 without looking at the center fascia 20, and thus driving stability may be improved compared to a related art.

The flowchart of FIG. 3 shows a process when the driver seat is located at the right side. In particular, a driver may release a left hand from the steering wheel and contact an operation unit in the center fascia. Accordingly, when the controller determines operation of the operation unit by a driver, the difference of the process is in determining using a signal from the left touch sensor that the contact of the left hand with the steering wheel is released or made.

In a system and method for improving driving safety according to an embodiment of the present invention, when a driver operates the operation part (e.g., the operation units) in the center fascia, a driver may operate in-vehicle apparatuses by viewing the information of the cluster or the head-up display which is relatively lower than the center fascia. Accordingly, the safe driving may be achieved without an attention dispersion of a driver. Additionally, since it becomes difficult for a driver to operate the steering wheel when a driver operates the operation units of the center fascia, the steering stability may be improved. Furthermore, since a driver may be warned of one-hand driving state, the driving safety may be improved.

The invention has been described in detail with reference to exemplary embodiments thereof. However, it will be appreciated by those skilled in the art that changes, modifications and variations may be made in these embodiments without departing from the principles and spirit of the invention, the scope of which is defined in the accompanying claims and their equivalents.

What is claimed is:

1. A system for improving safety stability upon operation of in-vehicle apparatuses during driving, the system comprising:
a left touch sensor disposed at a left region of a steering wheel gripped by a left hand of a driver, wherein the left touch sensor is configured to sense a contact of the left hand with the steering wheel to output a signal;
a right touch sensor disposed at a right region of the steering wheel gripped by a right hand of the driver, wherein the right touch sensor is configured to sense a contact and of the right hand with the steering wheel to output a signal;
an operation unit touch sensor disposed in an operation unit of a center fascia configured to sense a touch and output a signal;
a controller configured to :
receive the plurality of signals from the left touch sensor, the right touch sensor, and the operation unit touch sensor to determine a driver contact with the operation unit of the center fascia; and
output a control signal for displaying operation unit information comprising a type and a purpose of the operation unit touched by the driver and a current operation location and state; and
an information display disposed at a front of a driver seat, wherein the information display is configured to display the information of the operation unit in response to the control signal of the controller.

2. The system of claim 1, wherein the controller is configured to:
receive a signal in response from the driver contact with the operation unit;
control the information display at the front of the driver seat; and
display an operated state of the operation unit.

3. The system of claim 1, wherein the information display includes one or both of a cluster and a head-up display.

4. The system of claim 1, wherein the controller is configured to:
determine, from the signals of the left and right touch sensors, when a contact of one driver hand with the steering wheel is released;
receive the signal according to the hand touch from the operation unit touch sensor within a certain time; and
in response to determining no contact of the driver hand with the steering wheel, determining that the operation unit of the center fascia is contacted by the driver.

5. The system of claim 1, wherein the controller outputs a control signal for steering control of the steering wheel to reduce a steering assist of a motor driven power steering when the controller determines contact of the driver with the operation unit of the center fascia.

6. The system of claim 1, further comprising a warning unit for warning the driver of one-hand driving state, wherein the controller is configured to:
determine, from the signals of the left and right touch sensors, when a contact of one driver hand with the steering wheel is released; and
in response to determining the release of the driver hand for a certain time, actuate the warning unit to warn the driver of the one hand driving state.

7. A method for improving safety stability upon operation of in-vehicle apparatuses during driving, the method comprising:
receiving, by a controller, a plurality of signals from a left touch sensor and a right touch sensor disposed to sense a contact of a left hand and a right hand with the steering wheel and a signal from an operation unit touch sensor disposed at each operation unit of a center fascia to sense a hand touch;
determining, by the controller, the hand touch of a driver with the operation unit of the center fascia;
outputting, by the controller, a control signal for displaying operation unit information comprising a type and a purpose of the operation unit touched by the driver hand and a current operation location and state; and
displaying, by the controller, on an information display disposed at a front of a driver seat, the information of the operation unit touched by the driver hand in response to the control signal of the controller.

8. The method of claim 7, wherein the controller receives a signal in response to the operation of the driver from the operation unit touched by the driver hand to operate the information display at the front of the driver seat to display an operated state of the operation unit.

9. The method of claim 7, wherein the information display comprises one or both of a cluster and a head-up display.

10. The method of claim 7, further comprising:
determining, by the controller, from the signals of the left and right touch sensors when a contact of one driver hand with the steering wheel is released;
receiving, by the controller, the signal in response to the driver hand touch from the operation unit touch sensor within a certain time; and
in response to determining no contact of the driver hand with the steering wheel, determining that the operation unit of the center fascia is contacted by the driver.

11. The method of claim 7, wherein the controller outputs a control signal for steering control of the steering wheel to reduce a steering assist of a motor driven power steering when the controller determines the driver hand touch with the operation unit of the center fascia.

12. The method of claim 7, further comprising:
warning, by a warning unit, the driver of one-hand driving state, wherein the controller determines from the signals of the left and right touch sensors that a contact of one driver hand with the steering wheel is released; and
in response to determining the release of the driver hand for a certain time, actuating, by the controller, the warning unit to warn the driver of the one hand driving state.

13. A non-transitory computer readable medium containing program instructions executed by a controller, the computer readable medium comprising:
program instructions that receive a plurality of signals from a left touch sensor and a right touch sensor disposed to sense a contact of a left hand and a right hand with the steering wheel and a signal from an operation unit touch sensor disposed at each operation unit of a center fascia to sense a hand touch;
program instructions that determine the hand touch of a driver with the operation unit of the center fascia;
program instructions that output a control signal for displaying operation unit information comprising a type and a purpose of the operation unit touched by the driver hand and a current operation location and state; and
program instructions that display on an information display disposed at a front of a driver seat, the information of the operation unit touched by the driver hand in response to the control signal of the controller.

14. The computer readable medium of claim 13, further comprising program instructions that receive a signal in response to the operation of the driver from the operation unit touched by the driver hand to operate the information display at the front of the driver seat to display an operated state of the operation unit.

15. The computer readable medium of claim 13, wherein the information display comprises one or both of a cluster and a head-up display.

16. The computer readable medium of claim 13, further comprising:
program instructions that determine from the signals of the left and right touch sensors when a contact of one driver hand with the steering wheel is released;
program instructions that receive the signal in response to the driver hand touch from the operation unit touch sensor within a certain time; and
program instructions that determine that the operation unit of the center fascia is contacted by the driver, in response to determining no contact of the driver hand with the steering wheel.

17. The computer readable medium of claim 13, further comprising program instructions that output a control signal for steering control of the steering wheel to reduce a steering assist of a motor driven power steering when the controller determines the driver hand touch with the operation unit of the center fascia.

18. The computer readable medium of claim 13, further comprising:
program instructions that determine from the signals of the left and right touch sensors that a contact of one driver hand with the steering wheel is released; and
program instructions that warn the driver of the one hand driving state.
